(19) United States
(12) Patent Application Publication
(10) Pub. No.: US 2017/0130948 A1
(43) Pub. Date: May 11, 2017

(54) HIGH -BRIGHTNESS PANEL HEAT-DISSIPATING APPARATUS

(71) Applicant: LITEMAX ELECTRONICS INC., NEW TAIPEI CITY (TW)

(72) Inventor: TIEN-TENG YANG, NEW TAIPEI CITY (TW)

(21) Appl. No.: 14/933,460

(22) Filed: Nov. 5, 2015

(51) Int. Cl. F21V 29/70; F21V 29/67

(52) U.S. Cl. CPC F21V 29/70; F21V 29/677

(57) ABSTRACT

A high-brightness panel heat-dissipating apparatus includes a frame for fixing the high-brightness panel in place, with a top gap disposed between the high-brightness panel and a ceiling of the frame; a transparent plate disposed in front of the frame, with a front gap disposed between the transparent plate and an observation portion of the high-brightness panel; a roller-style fan disposed between the high-brightness panel and a floor of the frame; a heat-dissipating plate disposed behind the frame, with a rear gap disposed between the heat-dissipating plate and the rear of the high-brightness panel; a gas-discharging opening formed at the heat-dissipating plate and positioned near the top of the frame; a gas-guiding opening formed at the heat-dissipating plate and disposed below the gas-discharging opening; a gas-discharging fan disposed at the gas-discharging opening; and a gas-guiding fan disposed at the gas-guiding opening. The gas-discharging and gas-guiding openings communicate with rear gap.

### FIELD OF TECHNOLOGY

The present invention relates to panel heat-dissipating apparatuses and more particularly to a high-brightness panel heat-dissipating apparatus disposed at the front and rear of a heat-dissipating high-brightness panel.

### BACKGROUND

When a conventional high-brightness panel is provided outdoors, an observation portion of the high-brightness panel is often exposed to sunlight and thus overheated and charred, thereby getting damaged.

With the high-brightness panel being a high-precision product, it is required to be wind-proof, dustproof and waterproof when provided outdoors.

Accordingly, it is imperative to provide a high-brightness panel heat-dissipating apparatus which is not only wind-proof, dustproof and waterproof but is also capable of dissipating heat from a high-brightness panel.

### SUMMARY

In view of the aforesaid drawbacks of the prior art, it is an objective of the present invention to provide a high-brightness panel heat-dissipating apparatus which is not only wind-proof, dustproof and waterproof but is also capable of dissipating heat from a high-brightness panel.

In order to achieve the above and other objectives, the present invention provides a high-brightness panel heat-dissipating apparatus, adapted to dissipate heat from a high-brightness panel, the high-brightness panel heat-dissipating apparatus comprising: a frame for fixing the high-brightness panel in place, with a top gap disposed between the high-brightness panel and a ceiling of the frame; a transparent plate disposed in front of the frame, with a front gap disposed between the transparent plate and an observation portion of the high-brightness panel; at least a roller-style fan disposed between the high-brightness panel and a floor of the frame; a heat-dissipating plate disposed behind the frame, with a rear gap disposed between the heat-dissipating plate and a rear portion of the high-brightness panel; at least a gas-discharging opening penetratingly disposed at the heat-dissipating plate and positioned proximate to the top of the frame; at least a gas-guiding opening penetratingly disposed at the heat-dissipating plate and disposed below the gas-discharging openings; at least a gas-discharging fan disposed at the gas-discharging opening; and at least a gas-guiding fan disposed at the gas-guiding opening, wherein the gas-discharging opening and the gas-guiding opening are in communication with the rear gap, and the rear gap, the roller-style fan, the front gap and the top gap are in communication with each other.

Regarding the high-brightness panel heat-dissipating apparatus, the heat-dissipating plate further has a first baffle plate disposed at the gas-discharging opening and a second baffle plate disposed at the gas-guiding opening.

Regarding the high-brightness panel heat-dissipating apparatus, a top of the first baffle plate is disposed at a top of the gas-discharging opening, with the first baffle plate tilting and having a bottom thereof positioned distal to the gas-discharging opening, wherein a top of the second baffle plate is disposed at a top of the gas-guiding opening, with the second baffle plate tilting and having a bottom thereof positioned distal to the gas-guiding opening.

Regarding the high-brightness panel heat-dissipating apparatus, the transparent plate is a transparent glass plate or a transparent plastic plate.

Regarding the high-brightness panel heat-dissipating apparatus, the gas-guiding opening is positioned proximate to the roller-style fan.

The high-brightness panel heat-dissipating apparatus, further comprises at least a dustproof element removably fixed on a side of the gas-guiding opening, wherein the side of the gas-guiding opening faces away from the rear gap.

In conclusion, due to its aforesaid configuration, the high-brightness panel heat-dissipating apparatus of the present invention efficiently dissipates heat from the high-brightness panel from the front and rear.

### BRIEF DESCRIPTION

Objectives, features, and advantages of the present invention are hereunder illustrated with specific embodiments in conjunction with the accompanying drawings, in which:

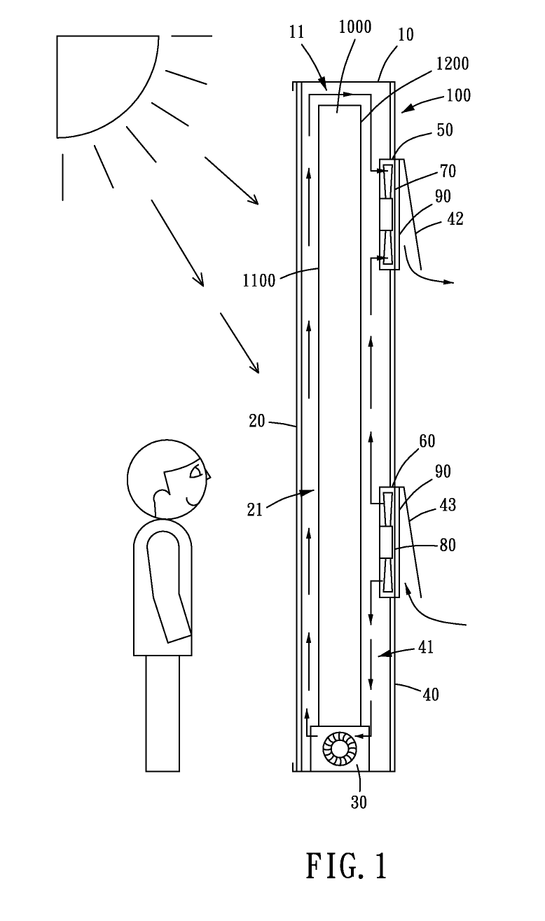

FIG. 1 is a cross-sectional view of a high-brightness panel heat-dissipating apparatus of the present invention; and

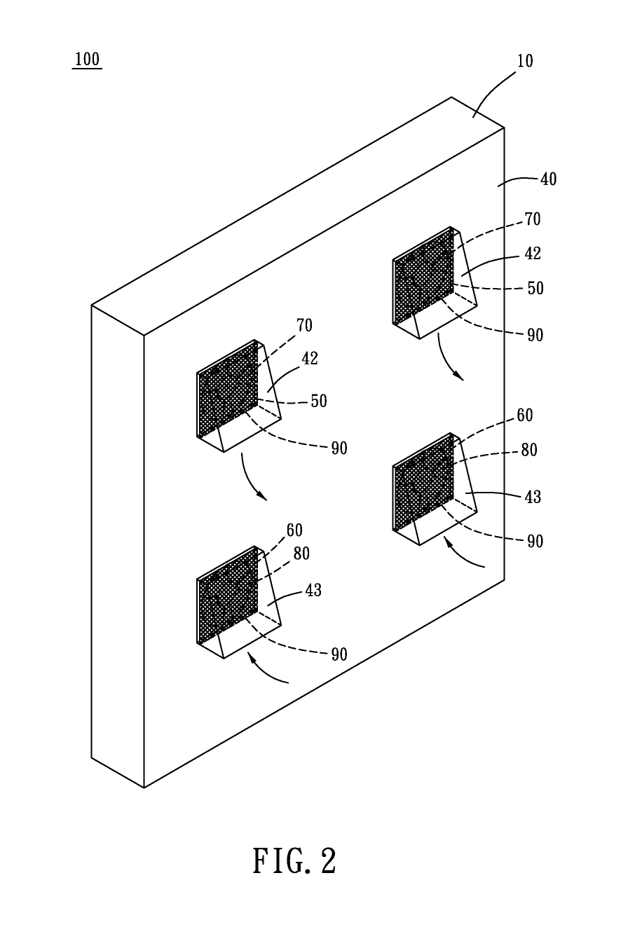

FIG. 2 is a rear view of the high-brightness panel heat-dissipating apparatus of the present invention.

### DETAILED DESCRIPTION

Referring to FIG. 1 and FIG. 2, the present invention provides a high-brightness panel heat-dissipating apparatus 100 for dissipating heat from a high-brightness panel 1000. The high-brightness panel heat-dissipating apparatus 100 comprises a frame 10, a transparent plate 20, at least a roller-style fan 30, a heat-dissipating plate 40, at least a gas-discharging opening 50, at least a gas-guiding opening 60, at least a gas-discharging fan 70 and at least a gas-guiding fan 80.

When operating, the high-brightness panel 1000 generates heat. The high-brightness panel 1000 is dedicated to outdoor use and exposed to sunlight, but the present invention is not limited thereto. An observation portion 1100 is disposed at the front of the high-brightness panel 1000. A rear portion 1200 is disposed at the rear of the high-brightness panel 1000. Electronic parts and components are mounted on the rear portion 1200. When irradiated with sunlight, the observation portion 1100 generates heat. In case of long use, the operating electronic parts and components mounted on the rear portion 1200 generate heat. The other fine structures of the high-brightness panel 1000 are not shown in FIG. 1 and FIG. 2.

The frame 10 fixes the high-brightness panel 1000 in place. To be specific, the two lateral sides of the high-brightness panel 1000 are fixed in place by the frame 10, such that a top gap 11 is disposed between the top of the high-brightness panel 1000 and the ceiling of the frame 10.

The transparent plate 20 is disposed in front of the frame 10. A front gap 21 is disposed between the transparent plate 20 and an observation portion 1100 of the high-brightness panel 1000. The top gap 11 is in communication with the front gap 21. The transparent plate 20 is a transparent glass plate or a transparent plastic plate, such that the observation portion 1100 of the high-brightness panel 1000 is dustproof and waterproof.

The roller-style fan 30 is disposed between the bottom of the high-brightness panel 1000 and the floor of the frame 10. The roller-style fan 30 is in communication with the front gap 21. The quantity of the roller-style fans 30 depends on the transverse width of the high-brightness panel 1000. For example, if the high-brightness panel 1000 has a transverse width of 47 inches, the roller-style fans 30 are in the number of two, but the present invention is not limited thereto, as the quantity of the roller-style fans 30 is subject to changes.

The heat-dissipating plate 40 is disposed behind the frame 10. A rear gap 41 is disposed between the heat-dissipating plate 40 and the rear portion 1200 of the high-brightness panel 1000. The top gap 11 is in communication with the rear gap 41 from above. The roller-style fan 30 is in communication with the rear gap 41 from below.

The gas-discharging opening 50 is penetratingly disposed at the heat-dissipating plate 40 and positioned proximate to the top of the frame 10. The quantity of the gas-discharging opening 50 depends on the transverse width of the high-brightness panel 1000. For example, if the high-brightness panel 1000 has a transverse width of 47 inches, the gas-discharging openings 50 are in the number of two, but the present invention is not limited thereto, as the quantity of the gas-discharging openings 50 is subject to changes.

The gas-guiding opening 60 is penetratingly disposed at the heat-dissipating plate 40 and disposed below the gas-discharging openings 50. The quantity of the gas-guiding openings 60 depends on the transverse width of the high-brightness panel 1000. For example, if the high-brightness panel 1000 has a transverse width of 47 inches, the gas-guiding openings 60 are in the number of two, but the present invention is not limited thereto, as the quantity of the gas-guiding openings 60 is subject to changes.

The gas-discharging fan 70 is disposed at the gas-discharging opening 50. Hence, the gas-discharging fans 70 correspond in quantity to the gas-discharging openings 50. The gas-discharging fans 70 draw air from the rear gap 41 and then discharge the air from the frame 10.

The gas-guiding fans 80 are disposed at the gas-guiding openings 60. Hence, the gas-guiding fans 80 correspond in quantity to the gas-guiding openings 60. Air outside the frame 10 is introduced into the rear gap 41 with the gas-guiding fans 80.

Referring to FIG. 1, the high-brightness panel 1000 is fixed in place by the frame 10 and placed at an outdoor location which is exposed to sunlight. The rear portion 1200 of the high-brightness panel 1000 generates heat, and the observation portion 1100 of the high-brightness panel 1000 generates heat when exposed to sunlight; the temperature outside the frame 10 is lower than the temperature inside the frame 10.

Low-temperature air is conveyed from the gas-guiding opening 60 to the rear gap 41 with the gas-guiding fan 80. Both the roller-style fan 30 and the gas-discharging fan 70 guide the air in drifting up and down simultaneously. The up-drifting air dissipates heat from the rear portion 1200 of the high-brightness panel 1000. Due to the principle that hot air rises and cool air sinks, air whose temperature is rising because of heat dissipation keeps rising and thus is discharged from the frame 10 through the gas-discharging opening 50 by the gas-discharging fan 70. The down-drifting air is conveyed to the front gap 21 by the roller-style fan 30 and dissipates heat from the observation portion 1100 of the high-brightness panel 1000. Similarly, due to the principle that hot air rises and cool air sinks, air whose temperature is rising because of heat dissipation keeps rising and thus moves to the top gap 21 to thereby be discharged from the frame 10 through the gas-discharging opening 50 by the gas-discharging fan 70.

Therefore, because of its aforesaid structure and configuration, the high-brightness panel heat-dissipating apparatus 100 of the present invention dissipates heat from the high-brightness panel from the front and rear simultaneously.

To make good use of the low-temperature conveyed from the gas-guiding opening 60 to the rear gap 41 with the gas-guiding fan 80, the gas-guiding opening 60 is preferably positioned proximate to the roller-style fan 30 such that, before being heated up, the down-drifting air is already introduced into the front gap 21 to dissipate heat from the observation portion 1100 of the high-brightness panel 1000, not to mention that the up-drifting air can pass the rear portion 1200 of the high-brightness panel 1000 more extensively.

Referring to FIG. 1 and FIG. 2, the heat-dissipating plate 40 further has a first baffle plate 42 and a second baffle plate 43. The first baffle plate 42 is disposed at the gas-discharging opening 50. The second baffle plate 43 is disposed at the gas-guiding opening 60. On a rainy day, rainwater is prevented from intruding into the frame 10 through the gas-discharging opening 50 or the gas-guiding opening 60, thereby preventing rainwater from damaging the high-brightness panel 1000.

To prevent air drawn into the rear gap 41 or discharged from the rear gap 41 from being affected by rainwater and prevent rainwater from accumulating at the frame 10 or the heat-dissipating plate 40, it is preferred that the top of the first baffle plate 42 should be disposed at the top of the gas-discharging opening 50, that the first baffle plate 42 should tilt and have its bottom positioned distal to the gas-discharging opening 50, that the top of the second baffle plate 43 should be disposed at the top of the gas-guiding opening 60, and that the second baffle plate 43 should tilt and have its bottom positioned distal to the gas-guiding opening 60.

To prevent dust from intruding into the frame 10, the high-brightness panel heat-dissipating apparatus 100 further comprises at least a dustproof element 90 fixed to one side of the gas-guiding opening 60 by means of track sliding, engagement, clamping, insertion, and the like, wherein the one side of the gas-guiding opening 60 faces away from the rear gap 41. Therefore, if dusty air is conveyed from the gas-guiding opening 60 to the rear gap 41 with the gas-guiding fan 80, the dusty air will be trapped in the dustproof element 90 to thereby prevent dust from intruding into the frame 10. With the dustproof element 90 being fixed in place by means of track sliding, engagement, clamping, insertion, and the like, it can be mounted and dismounted quickly and thus changed easily.

In conclusion, because of its aforesaid structure and configuration, a high-brightness panel heat-dissipating apparatus of the present invention dissipates heat from the high-brightness panel from the front and rear simultaneously. The high-brightness panel heat-dissipating apparatus of the present invention is equipped with a first baffle plate and a second baffle plate whereby rainwater is prevented from intruding into the frame through a gas-discharging opening and a gas-guiding opening.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A high-brightness panel heat-dissipating apparatus, adapted to dissipate heat from a high-brightness panel, the high-brightness panel heat-dissipating apparatus comprising:
a frame for fixing the high-brightness panel in place, with a top gap disposed between the high-brightness panel and a ceiling of the frame;
a transparent plate disposed in front of the frame, with a front gap disposed between the transparent plate and an observation portion of the high-brightness panel;
at least a roller-style fan disposed between the high-brightness panel and a floor of the frame;
a heat-dissipating plate disposed behind the frame, with a rear gap disposed between the heat-dissipating plate and a rear portion of the high-brightness panel;
at least a gas-discharging opening penetratingly disposed at the heat-dissipating plate and positioned proximate to the top of the frame;
at least a gas-guiding opening penetratingly disposed at the heat-dissipating plate and disposed below the gas-discharging opening;
at least a gas-discharging fan disposed at the gas-discharging opening; and
at least a gas-guiding fan disposed at the gas-guiding opening,
wherein the gas-discharging opening and the gas-guiding opening are in communication with the rear gap, and the rear gap, the roller-style fan, the front gap and the top gap are in communication with each other.

2. The high-brightness panel heat-dissipating apparatus of claim 1, wherein the heat-dissipating plate further has a first baffle plate disposed at the gas-discharging opening and a second baffle plate disposed at the gas-guiding opening.

3. The high-brightness panel heat-dissipating apparatus of claim 2, wherein a top of the first baffle plate is disposed at a top of the gas-discharging opening, with the first baffle plate tilting and having a bottom thereof positioned distal to the gas-discharging opening, wherein a top of the second baffle plate is disposed at a top of the gas-guiding opening, with the second baffle plate tilting and having a bottom thereof positioned distal to the gas-guiding opening.

4. The high-brightness panel heat-dissipating apparatus of claim 1, wherein the transparent plate is one of a transparent glass plate and a transparent plastic plate.

5. The high-brightness panel heat-dissipating apparatus of claim 2, wherein the transparent plate is one of a transparent glass plate and a transparent plastic plate.

6. The high-brightness panel heat-dissipating apparatus of claim 3, wherein the transparent plate is one of a transparent glass plate and a transparent plastic plate.

7. The high-brightness panel heat-dissipating apparatus of claim 4, wherein the gas-guiding opening is positioned proximate to the roller-style fan.

8. The high-brightness panel heat-dissipating apparatus of claim 5, wherein the gas-guiding opening is positioned proximate to the roller-style fan.

9. The high-brightness panel heat-dissipating apparatus of claim 6, wherein the gas-guiding opening is positioned proximate to the roller-style fan.

10. The high-brightness panel heat-dissipating apparatus of claim 1, wherein the gas-guiding opening is positioned proximate to the roller-style fan.

11. The high-brightness panel heat-dissipating apparatus of claim 2, wherein the gas-guiding opening is positioned proximate to the roller-style fan.

12. The high-brightness panel heat-dissipating apparatus of claim 3, wherein the gas-guiding opening is positioned proximate to the roller-style fan.

13. The high-brightness panel heat-dissipating apparatus of claim 10, further comprising at least a dustproof element removably fixed on a side of the gas-guiding opening, wherein the side of the gas-guiding opening faces away from the rear gap.

14. The high-brightness panel heat-dissipating apparatus of claim 11, further comprising at least a dustproof element removably fixed on a side of the gas-guiding opening, wherein the side of the gas-guiding opening faces away from the rear gap.

15. The high-brightness panel heat-dissipating apparatus of claim 12, further comprising at least a dustproof element removably fixed on a side of the gas-guiding opening, wherein the side of the gas-guiding opening faces away from the rear gap.

16. The high-brightness panel heat-dissipating apparatus of claim 1, further comprising at least a dustproof element removably fixed on a side of the gas-guiding opening, wherein the side of the gas-guiding opening faces away from the rear gap.

17. The high-brightness panel heat-dissipating apparatus of claim 2, further comprising at least a dustproof element removably fixed on a side of the gas-guiding opening, wherein the side of the gas-guiding opening faces away from the rear gap.

18. The high-brightness panel heat-dissipating apparatus of claim 3, further comprising at least a dustproof element removably fixed on a side of the gas-guiding opening, wherein the side of the gas-guiding opening faces away from the rear gap.
